(19) United States
(12) Patent Application Publication
(10) Pub. No.: US 2014/0176110 A1
(43) Pub. Date: Jun. 26, 2014

(54) Output Driver Having Reduced Electromagnetic Susceptibility and Associated Methods

(71) Applicants: Washington Lamar, Mont Vernon, NH (US); Maxim Klebanov, Newton, MA (US)

(72) Inventors: Washington Lamar, Mont Vernon, NH (US); Maxim Klebanov, Newton, MA (US)

(21) Appl. No.: 13/727,108

(22) Filed: Dec. 26, 2012

(51) Int. Cl. G05F 3/02

(52) U.S. Cl. CPC G05F 3/02
USPC 323/311

(57) ABSTRACT

An electronic circuit includes a driver circuit having an output terminal that can be coupled to a load to drive the load. A control circuit may be coupled to the driver circuit for controlling the driver circuit. A transistor may be coupled in series between the driver circuit and the output terminal. The transistor may have a first terminal coupled to the driver circuit and a second terminal coupled to the output terminal. A biasing circuit may be coupled to a gate terminal of the transistor and configured to bias the transistor to a conducting state. The biasing circuit may have sufficient drive strength to maintain the transistor in the conducting state in the presence of electromagnetic interference.

### FIELD

Subject matter disclosed herein relates generally to integrated circuits and, more particularly, to techniques and circuits for reducing the electromagnetic susceptibility of driver circuitry within integrated circuits.

### BACKGROUND

A weakly driven output driver circuit can be susceptible to pulsed radiated and conducted electromagnetic interference (EMI) noise sources. Transients from EMI sources can cause the output driver to change state, resulting in false output pulses or no output at all. This issue can be exacerbated if the driver is connected to a load circuit via a long conductor. The long conductor can act as an antenna that couples the EMI into the circuit to cause transient errors.

Various techniques can be used to reduce a circuit's susceptibility to electromagnetic interference. These techniques include improving shielding of the circuit or cable, addition of ferrite beads, filtering, modification of ground and power plane routing, etc. However, these techniques can be expensive or impractical in certain circuits. If, for example, the driver circuit is part of a remote sensor, it may be difficult to modify ground and power routing, or cost prohibitive to add shielding or ferrite beads.

### SUMMARY

An electronic circuit includes a driver circuit having an output terminal that can be coupled to a load to drive the load. A control circuit may be coupled to the driver circuit for controlling the driver circuit. A transistor may be coupled in series between the driver circuit and the output terminal. The transistor may have a first terminal coupled to the driver circuit and a second terminal coupled to the output terminal. A biasing circuit may be coupled to a gate terminal of the transistor and configured to bias the transistor to a conducting state. The biasing circuit may have sufficient drive strength to maintain the transistor in the conducting state in the presence of electromagnetic interference.

A method for driving a load includes providing an output terminal that can be coupled to load. The driver circuit may be controlled by a control circuit coupled to the driver circuit. A transistor may be coupled in series between the driver circuit and the output terminal. The transistor may have a first terminal coupled to the driver circuit, a second terminal coupled to the output terminal, and a gate terminal. The gate terminal of the transistor may be coupled to a biasing circuit configured to bias the transistor in a conducting state. The biasing circuit may drive the gate terminal of the transistor with sufficient strength to maintain the transistor in a conducting state in the presence of electromagnetic interference.

### BRIEF DESCRIPTION OF THE DRAWINGS

The foregoing features may be more fully understood from the following description of the drawings in which:

FIG. 1 is a schematic diagram illustrating a conventional output driver circuit;

FIG. 2 is a graph of a waveform illustrating an ideal output of an output driver circuit;

FIG. 3 is a schematic diagram of an embodiment of an output driver circuit;

FIG. 3A is a schematic diagram of an embodiment of an output driver circuit; and

FIG. 3B is a schematic diagram of an embodiment of an output driver circuit.

Like figures in the drawings may represent like elements.

### DETAILED DESCRIPTION

As used herein, the term “magnetic field sensing element” is used to describe a variety of electronic elements that can sense a magnetic field. The magnetic field sensing element can be, but is not limited to, a Hall effect element, a magnetoresistance element, or a magnetotransistor. As is known, there are different types of Hall effect elements, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of sensitivity perpendicular to a substrate, while metal based or metallic magnetoresistance elements (e.g., GMR, TMR, AMR) and vertical Hall elements tend to have axes of sensitivity parallel to a substrate.

As used herein, the term “magnetic field sensor” is used to describe a circuit that uses a magnetic field sensing element, generally in combination with other circuits. Magnetic field sensors are used in a variety of applications, including, but not limited to, an angle sensor that senses an angle of a direction of a magnetic field, a current sensor that senses a magnetic field generated by a current carried by a current-carrying conductor, a magnetic switch that senses the proximity of a ferromagnetic object, a rotation detector that senses passing ferromagnetic articles, for example, magnetic domains of a ring magnet or perturbations in a magnetic field generated by a back bias magnet where the perturbations are caused by a rotating ferromagnetic article, and a magnetic field sensor that senses a magnetic field density of a magnetic field.

Magnetic field sensors often include driver circuits that can drive an output signal of the magnetic field sensor. These driver circuits often produce an output signal that switches between a high and low depending upon whether a magnetic field sensing element senses a magnetic target or a magnetic field of a particular strength. In some cases, depending upon the location where the magnetic field sensor is installed, the driver circuit may have to drive the output signal across a long conductor or cable harness. For example, if the magnetic field sensor is installed in a vehicle's transmission (e.g. on a camshaft), the conductor harness running from the magnetic field sensor to a central processor may be a few feet or a few meters in length. Such a long cable may be susceptible to EMI from the vehicle's engine, transmission, or other circuits.

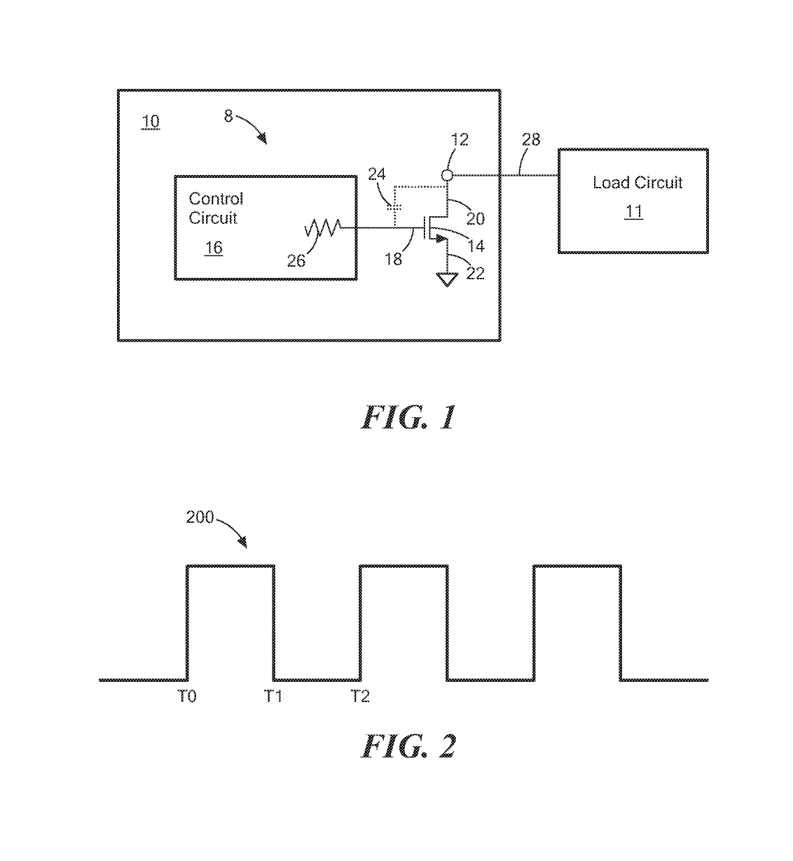

FIG. 1 is a schematic diagram illustrating a conventional output driver circuit 8 that may be used to provide an output signal for an integrated circuit (IC) 10. For example, a load circuit 11 may be connected to an output terminal 12 of the IC 10. As illustrated, output driver circuit 8 may include a driver device 14 and a control circuit 16. The output driver device 14 may be a transistor such as, for example, a field effect transistor (FET) that includes a gate terminal 18, a drain terminal 20, and a source terminal 22. The drain terminal 20 of the output driver device 14 may be coupled to the output terminal 12 and the load circuit 11.

Output driver device 14 includes a gate-to-drain parasitic capacitance (Cgd) 24 and a gate-to-source parasitic capacitance (Cgs) (not shown). As will be appreciated, these parasitic capacitances may provide a degree or amount of coupling between gate terminal 18 and drain and source terminals 20, 22, respectively. In cases where output driver device 14 is being weakly driven by gate control circuit 16, electromagnetic interference (EMI) received at the integrated circuit (from, for example, a pulsed radar system or other EMI source that can couple to the conductor 28) can couple through one or both of the parasitic capacitances and change the output state of device 14. This can create errors in the data delivered to the load device.

A transistor may be considered “weakly driven” when a drive source has a relatively high impedance with relatively low current capability, resulting in slower device turn-on. For example, control circuit 16 may have an output resistance 26. If resistance 26 is high, control circuit 16 may drive gate terminal 18 relatively weakly, which may allow external forces such as EMI to cause interference with the operation of electronic circuit 8.

During operation, gate control circuit 16 drives the gate terminal 18 of the output driver device 14 such that when a threshold voltage is reached the device conducts to generate transition between a high voltage (i.e. a logic one) and a low voltage (i.e. a logic zero) signal value on output terminal 12. An intermediate voltage may also be generated.

In an embodiment, load circuit 11 may be a pull-up resistor that pulls the voltage at the output terminal 12 high when the driver device 14 is not conducting. When the driver device 14 is conducting, the driver device 14 may pull the voltage at the output terminal 12 down to a voltage at or near ground. Note that although the example above assumes that a high voltage is a logic one and a low voltage is a logic zero, in an embodiment, a high voltage may be interpreted as a logic zero and a low voltage may be interpreted as a logic one, depending upon design requirements. The load circuit 11 may also be an LED, a bank of LEDs, a motor, or any other type of load that can be driven by the driver device 14.

FIG. 2 is a waveform diagram of an ideal output of the driver device 14. The horizontal axis of the waveform 200 is time and the vertical axis is voltage. At time T0 the control circuit 16 may drive the gate terminal 18 so that the voltage at the output terminal 12 becomes high. At time T1, the control circuit 16 may drive the the gate terminal 18 so that the voltage at the output terminal 12 becomes low. The control circuit 16 may continue to drive the gate terminal 18 as required so that the voltage at the output terminal 12 becomes high and low accordingly. As shown in FIG. 2, the control circuit 16 may drive the gate terminal 18 so that an alternating voltage waveform occurs at the output terminal 12.

The parasitic capacitance 24 may, in some circumstances, create a failure mode that unintentionally causes the driver device 14 to change state (i.e. to unintentionally turn the driver device 14 on or off). This can cause errors in the output signal. For example, assume that the conductor 28 coupled between the output terminal 12 and the load circuit 11 acts as an antenna in the presence of EMI. EMI pulses on the conductor 28 may charge or discharge the parasitic capacitance 24, which may increase or decrease a voltage differential between the drain terminal 20 and the gate terminal 18. If the series resistance 26 is high enough, this voltage differential can effectively drive the gate terminal 18 of the driver device 14, resulting in the driver device 14 inadvertently switching state. When the driver device 14 inadvertently switches state, it may cause unintended transitions or aberrations on the waveform 200.

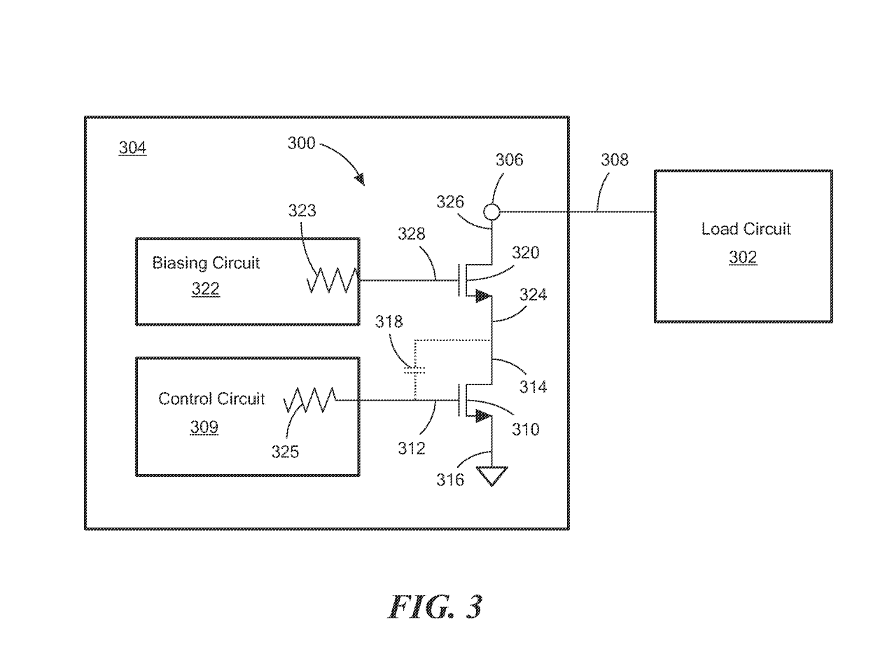

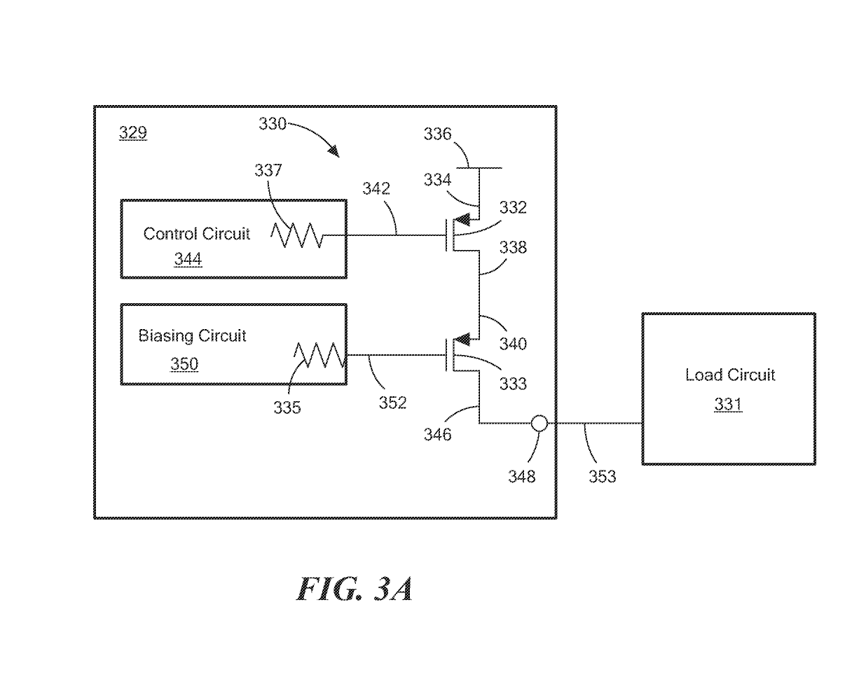

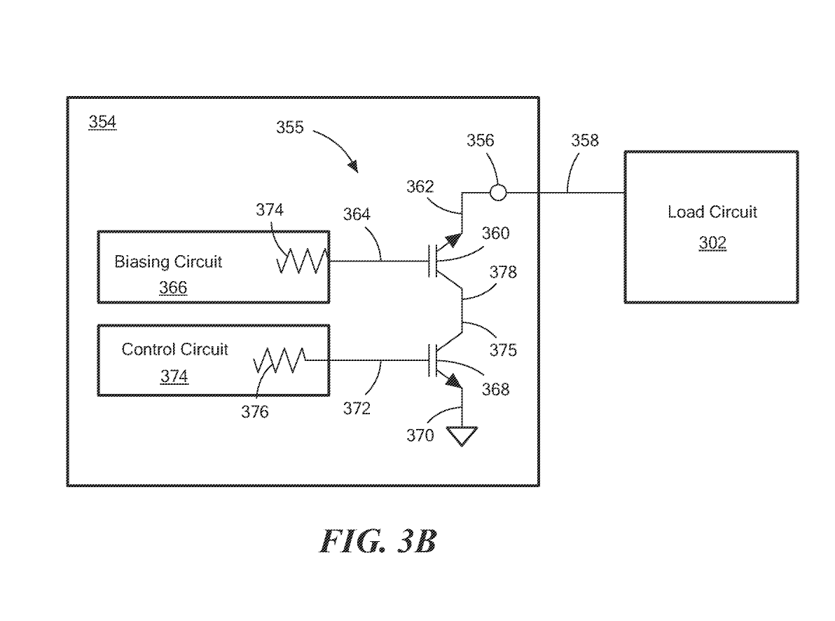

FIG. 3 is a block diagram of an electronic circuit (e.g. an IC) 304 containing a driver circuit 300 for driving a load circuit 302. The load circuit 302 may be a pull-up resistor. The load circuit 302 may also be an LED, a bank of LEDs, a motor, or any other type of load that can be driven by the driver circuit 300. In an embodiment, the driver circuit 300 can be an output driver of a magnetic field sensor 304 or other type of integrated circuit. As examples, a magnetic field sensor 304 may be installed in a vehicle in order to detect the speed, position, and/or direction of, for example, a camshaft or wheel. As a magnetic target, or features of a target such as gear teeth, on or coupled to a wheel or camshaft pass the magnetic field sensor 304, the magnetic field sensor 304 may drive an output to indicate a speed of rotation of the wheel or position of the camshaft, respectively. In an embodiment, the magnetic field sensor 304 may include an output driver circuit, such as the driver circuit 300, that can drive the output. The magnetic field sensor 304 may be implemented as an IC or as multiple ICs, which may comprise the driver circuit 300.

The driver circuit 300 may include a control circuit 309 and a driver device 310 for driving the load circuit 302. The driver device 310 may be an n-channel FET and may have a gate terminal 312, a drain terminal 314, and a source terminal 316. A parasitic capacitance 318 may be present between the drain terminal 314 and the gate terminal 312. The control circuit 309 may be coupled to and drive the gate terminal 312 of the driver device 310 so that the control circuit 309 can cause the driver device 310 to conduct or to turn off.

If the sensor 304 is installed within an automotive transmission, the conductor 308 may be relatively long, e.g., long enough to extend from the location of installation to a central processor. This may require the conductor 308 to be several inches long, several feet long, or several meters long. As described above, this can cause the conductor 308 to act as an antenna, which can charge and/or discharge the parasitic capacitance 318, cause the output of the driver device 310 to inadvertently change state, and introduce EMI-induced errors onto the output terminal 306.

To reduce the occurrence of such errors, the driver circuit 300 may include a buffer device 320 and a biasing circuit 322. In an embodiment, the buffer device 320 may be an n-channel FET and may comprise a source terminal 324 coupled to the drain terminal 314 of the driver device 310, a drain terminal 326 coupled to the output terminal 306, and a gate terminal 328 coupled to the biasing circuit 322. In other words, the buffer device 320 may be coupled in series between the output terminal 306 and the driver device 310. The buffer device 320 may also have a parasitic capacitance (not shown) between each pair of terminals, including between the drain terminal 326 and the gate terminal 328. In other embodiments, the buffer device 320 may be a BJT, a logic gate such as an inverter, or any other active circuit that can be driven to a conducting state. Also, although both the buffer device 320 and the driver device 310 are shown as the same type of component (i.e., shown as n-channel FETs), the buffer device 320 and the driver device 310 may be mixed and matched from different types of circuits or components. For example, in an embodiment, the buffer device 320 may be one of an n-channel FET, a p-channel FET, a BJT, a logic gate, multiple devices in series or parallel, or any appropriate type of buffer device 320, and the driver device 310 may be one of an n-channel FET, a p-channel FET, a BJT, a logic device, multiple devices in series or parallel, or any other appropriate driver device.

Although both the buffer device 320 and the driver device 310 are shown as n-channel FETs, either or both devices can be replaced by other circuits or devices including, but not limited to, npn BJTs, pnp BJTs, p-channel FETs, logic gates, multiple devices connected in series or parallel configurations, etc.

In operation, the biasing circuit 322 may drive the voltage at the gate terminal 328 so that the buffer device 320 remains on, i.e. in a conducting state. While the buffer device 320 is conducting, the buffer device 320 may not affect the ability of the driver device 310 to drive the output. In other words, when the buffer device 320 is on, the driver device 310 may still be able to pull the voltage at the output terminal 306 low. Also, with the buffer device 320 on, the driver device 310 may be able to enter a non-conducting state so that the voltage at the output terminal 306 can be pulled up to a logic one level by the load circuit 302.

In an embodiment, the biasing circuit 322 may provide a constant voltage to the gate terminal 328. For example, the biasing circuit 322 may set the voltage at the gate terminal 328 to a level that allows the buffer device 320 to remain in a conducting state. If the biasing device 320 is a FET, the biasing circuit 322 may set the voltage at the gate terminal 328 to place the FET into saturation or a conductive tri-state.

The biasing circuit 322 may have a relatively low output resistance 323 so that the buffer device 320 is not weakly driven. For example, the biasing circuit may be a resistor divider with relatively low resistance, a voltage regulator, or any other circuit with relatively low output resistance that can drive the gate terminal 328 to a particular voltage. In an embodiment, the output resistance 323 of the biasing circuit will be relatively lower than the output resistance of the output resistance 325 of the control circuit 309. This may allow the biasing circuit 322 to drive the buffer device 320 more strongly than the control circuit 309 drives the driver device 310.

The low output resistance 323 can help to reduce the effects of EMI interference from an external source. Assume that EMI pulses are introduced onto the conductor 308. The EMI pulses may act to charge or discharge the parasitic capacitance between the drain terminal 326 and the gate terminal 328. However, since the biasing circuit 322 has a relatively low output resistance 323, the biasing circuit 322 may be able to drive the gate terminal 328 strongly enough so that the EMI pulses are unable to cause the buffer device 320 to switch state. Since the buffer device 320 driven hard, it may be less likely to switch state in the presence of EMI, and it may act as a buffer and isolate the driver device 310 from the effects of EMI pulses on the conductor 308. In alternate embodiments the output resistance 323 may be equal to or greater than the output resistance 325, so long as the biasing circuit 322 can drive the gate terminal 328 more strongly than the control circuit 309 may drive the gate terminal 312.

FIG. 3A illustrates another embodiment of an electronic circuit 329 that may contain a driver circuit 330 for driving a load 331. The load circuit 331 may be a pull down resistor an LED, a bank of LEDs, a motor, or any other type of load that can be driven by the driver circuit 330. The electronic circuit 329 may be any type of circuit that drives a load 331, including, but not limited to an integrated circuit that includes a magnetic field sensor.

In FIG. 3A, a driver device 332 and a buffer device 333 may be p-channel FETs. The driver device 332 may have a source terminal 334 coupled to a voltage source 336, and a drain terminal 338 coupled to a source terminal 340 of the buffer device 333. A gate terminal 342 of the driver device 332 may be coupled to a control circuit 344. The buffer device 333 may have a drain terminal 346 coupled to an output terminal 348 of the electronic circuit 329. A biasing circuit 350 may be coupled to a gate terminal 352 of the buffer device 333. A conductor 353 may connect the output terminal 348 to the load circuit 331.

Although both the buffer device 333 and the driver device 332 are shown as p-channel FETs, either or both devices can be replaced by other circuits or devices including, but not limited to, npn BJTs, pnp BJTs, n-channel FETs, logic gates, multiple devices connected in series or parallel configurations, etc.

In operation, the control circuit 344 may drive the gate terminal 342 of the driver device 332 in order to turn the driver device 332 on and off. The biasing circuit 350 may drive the gate terminal 352 of the buffer device 333 to a voltage level that allows the buffer device 333 to remain in a conducting state. The biasing circuit 350 may have a relatively low output resistance 335 so that external interference does not alter the state of the buffer device 333. In an embodiment, the output resistance 335 may be relatively lower than the output resistance 337 of the control circuit 344. The relatively lower resistance 335 may allow the biasing circuit 350 to drive the gate terminal 352 more strongly than the control circuit 344 drives the gate terminal 342. However, this is not a requirement—in alternate embodiments the output resistance 335 may be equal to or greater than the output resistance 337, so long as the biasing circuit 350 can drive the gate terminal 352 more strongly than the control circuit 344 may drive the gate terminal 342.

As the driver device 332 turns on (i.e. enters a conducting state), the voltage at the output terminal 348 may be pulled high. As the driver device 332 turns off (i.e. enters a non-conducting state), the voltage at the terminal 348 may be pulled low by the load circuit 331.

If EMI is coupled onto the conductor 353, the buffer device 333 may buffer the driver device 332 from the EMI. As a result, the EMI may tend to charge or discharge a parasitic capacitance (not shown) between the drain terminal 346 and the gate terminal 352 of the buffer device 333. However, the output resistance 335 of the biasing circuit 350 may be sufficiently low to allow the biasing circuit 350 to continue, in the presence of the EMI, to drive the gate terminal 352 to a level that maintains the buffer device 333 in an on state. This may reduce the occurrence of data errors on the output terminal 348 due to external EMI.

Referring to FIG. 3B, an embodiment of the invention may include BJT transistors. As shown, an electronic circuit 354 (e.g. an IC) may contain a driver circuit 355 for driving a load 302. The driver circuit 355 may have an output terminal 356 coupled, via a conductor 358, to the load circuit 302. The load circuit 302 may be a pull-up resistor or other circuit that tends to pull the voltage at the output terminal 356 up to a high voltage level. In an embodiment, the electronic circuit 354 may be any type of device that drives a load 302 including, but not limited to, an integrated circuit that includes a magnetic field sensor.

A buffer device 360 may comprise a BJT transistor having a collector terminal 362 coupled to the output terminal 356 and a base terminal 364 coupled to a biasing circuit 366. A driver device 368 may also be a BJT transistor, and may have an emitter terminal 370 coupled to ground and a base terminal 372 coupled to a control circuit 374. A collector terminal 375 of the driver device 368 may be coupled to an emitter terminal 378 of the buffer device 360 so that the buffer device 360 is connected in series between the driver device 368 and the output terminal 356. Although both the buffer device 360 and the driver device 368 are shown as npn BJTs, either or both of the buffer device 360 and the driver device 368 can be replaced by other circuits or devices including, but not limited to, pnp BJTs, n-channel FETs, p-channel FETs, logic gates, multiple devices connected in series or parallel configurations, etc.

Although both the buffer device 360 and the driver device 368 are shown as BJT transistors, either or both devices can be replaced by other circuits or devices including, but not limited to, npn BJTs, pnp BJTs, n-channel FETs, p-channel FETs, logic gates, multiple devices connected in series or parallel configurations, etc.

In operation, the biasing circuit 366 may drive a current into the base terminal 364 of the buffer device 360 in order to maintain the buffer device in an on state (i.e. a conducting state). The control circuit 374 may drive a current into the base terminal 372 to turn the driver device 368 on and off as desired. As the driver device 368 turns on and off, the voltage at the terminal 356 may alternate between a high voltage (i.e. a logic one voltage level) and a low voltage (i.e. a logic zero voltage level). In an embodiment, the output resistance 374 of the biasing circuit 366 may be relatively lower than the output resistance 376 of the control circuit 374 so that the biasing circuit 366 can drive the base terminal 364 more strongly than the control circuit 374 drives the base terminal 372. However, this is not a requirement. In some instances, the output resistance 374 may be equal to or greater than the output resistance 376, so long as the biasing circuit 366 is configured to drive the base terminal 364 more strongly than the control circuit 374 drives the base terminal 372.

The buffer device 360 may act as a so-called buffer by allowing the driver device 368 to control the voltage at the output terminal 356 while reducing the effect that external EMI may have on the driver device 368. For example, the biasing circuit 366 may have a relatively low output resistance 374 so that it can drive the base terminal 364 with a current of sufficient magnitude so that external EMI coupled to the conductor 358 does not cause the buffer device 360 to change state. This may reduce the occurrence of EMI-induced data errors on the output terminal 356.

Embodiments of the present invention may be used to drive the output of any type of IC. In one example, the present invention may be part of a magnetic sensor IC used to detect location, speed, and/or direction of a target. The magnetic sensor IC may include, for example, one or more Hall effect elements, giant magneto-resistance elements, or multiple elements of the same or different types for detecting a ferromagnetic target. In an embodiment, the magnetic sensor IC that can be installed in an automotive application.

In embodiments, the magnetic sensor can be installed in controllers and regulators such as motor drivers, lathe controllers, LED lighting controllers/switches, etc. In one such embodiment, the magnetic sensor can be installed on or near a camshaft in order to measure the position, speed, and/or direction of the camshaft, driveshaft, or wheel. The camshaft may be fitted with a ferromagnetic gear such that, as the gear moves past the magnetic sensor, the sensor can detect features of the gear such as teeth or magnetic regions. This data may be provided to a processor and used to monitor the position of the camshaft in order to control engine timing such as in a fuel injection system.

In some instances, installation of the magnetic sensor requires a relatively long conductor or harness to be installed between the magnetic field sensor and a processor located at some other location within the automobile. The conductor may be a few inches, a few feet, a few meters, or any other length according to the design of the vehicle.

The long conductor can act as an antenna to couple external EMI into the circuit, which can lead to inaccurate speed and position data. In an embodiment, the magnetic sensor may include an output driver that incorporates embodiments of the invention to reduce susceptibility to the EMI, and thus reduce the occurrence of data errors.

Although this example discusses use of the described embodiments in a vehicle, the embodiments described above may be used with any circuit that drives an output.

Having described exemplary embodiments of the invention, it will now become apparent to one of ordinary skill in the art that other embodiments incorporating the concepts may also be used. The embodiments contained herein should not be limited to disclosed embodiments but rather should be defined by the claims. All publications and references cited herein are expressly incorporated herein by reference in their entirety.

What is claimed is:

1. An electronic circuit comprising:
a driver circuit having an output terminal that can be coupled to a load to drive the load;
a control circuit coupled to the driver circuit for controlling the driver circuit;
a transistor coupled in series between the driver circuit and the output terminal, the transistor having a first terminal coupled to the driver circuit and a second terminal coupled to the output terminal; and
a biasing circuit coupled to a gate terminal of the transistor and configured to bias the transistor to a conducting state.

2. The electronic circuit of claim 1 wherein the load is one or more of: a pull-up resistor, a pull-down resistor, an LED, a bank of LEDs, and a motor.

3. The electronic circuit of claim 1 wherein the driver circuit is an electronic switch having a control terminal coupled to the control circuit.

4. The electronic circuit of claim 3 wherein the driver circuit is a field-effect transistor having a gate terminal coupled to the control circuit or a BJT transistor having a base terminal coupled to the control circuit.

5. The electronic circuit of claim 1 wherein the biasing circuit has an output resistance sufficiently low to maintain the transistor in the conducting state in the presence of electromagnetic interference.

6. The electronic circuit of claim 5 wherein the output resistance of the biasing circuit is lower than an output resistance of the control circuit.

7. The electronic circuit of claim 1 wherein the biasing circuit is configured to keep the transistor in a conducting state.

8. The electronic circuit of claim 1 wherein the biasing circuit is a voltage regulator or a current source.

9. The electronic circuit of claim 1 wherein the electronic circuit comprises an integrated circuit.

10. The electronic circuit of claim 9 wherein the integrated circuit is a magnetic field sensor.

11. A method comprising:
providing an output terminal that can be coupled to load;
driving the load with a driver circuit;
controlling the driver circuit with a control circuit coupled to the driver circuit;
coupling a transistor in series between the driver circuit and the output terminal, the transistor having a first terminal coupled to the driver circuit, a second terminal coupled to the output terminal, and a gate terminal; and
coupling the gate terminal of the transistor to a biasing circuit configured to bias the transistor in a conducting state.

12. The method of claim 11 wherein providing the output terminal includes coupling the output terminal to a pull-up or pull-down resistor.

13. The method of claim 11 wherein driving the load includes driving an electronic switch having a control terminal coupled to the control circuit.

14. The method of claim 11 wherein the driving the load includes driving a field-effect transistor having a gate terminal coupled to the control circuit or a BJT transistor having a base terminal coupled to the control circuit.

15. The method of claim 11 wherein coupling the gate terminal of the transistor to a biasing circuit includes coupling the gate terminal of the transistor to a biasing circuit having a sufficiently low output resistance to maintain the transistor in the conducting state in the presence of electromagnetic interference.

16. The method of claim 15 wherein coupling the gate terminal of the transistor to a biasing circuit includes coupling the gate terminal of the transistor to a biasing circuit having a lower output resistance than an output resistance of the control circuit.

17. The method of claim 11 further comprising maintaining the transistor in a conducting state by driving the transistor with the biasing circuit.

18. The method of claim 11 further comprising one of:
driving the gate terminal with a voltage regulator, wherein the biasing circuit comprises the voltage regulator; or
driving the gate terminal with a current source, wherein the biasing circuit comprises the current source.
